(19) United States
(12) Patent Application Publication
(10) Pub. No.: US 2012/0011824 A1
(43) Pub. Date: Jan. 19, 2012

(54) INTEGRAL LUBRICATION TUBE AND NOZZLE COMBINATION

(75) Inventors: Brian P. Cigal, Windsor, CT (US); Leslie C. Kurz, Hebron, CT (US); Fred NguyenLoc, Manchester, CT (US)

(73) Assignee: UNITED TECHNOLOGIES CORPORATION, Hartford, CT (US)

(21) Appl. No.: 12/837,838

(22) Filed: Jul. 16, 2010

(51) Int. Cl. F02C 7/06

(52) U.S. Cl. 60/39.08

(57) ABSTRACT

An assembly includes a tube fitting integrally joined with a nozzle and adapted with a plurality of passages to spray lubricating oil at components within a bearing compartment of a gas turbine engine. In another aspect, the tube fitting and the nozzle are attached to a lubrication tube such that the tube fitting and nozzle can be inserted or removed from the bearing compartment along with the lubrication tube without disassembling the bearing compartment.

### STATEMENT OF GOVERNMENT INTEREST

This invention was in part produced through funding under a U.S. Government sponsored program and the United States Government has certain rights therein.

### BACKGROUND

The present invention relates to gas turbine engines, and more particularly, to gas turbine engines with combination lubrication tube and nozzle assemblies.

The rotating shafts and other rotating turbomachinery of gas turbine engines are supported from a non-rotating structure by arrays of anti-friction bearings. In many engines, anti-friction bearings are enclosed in bearing compartments that allow the anti-friction bearings to be more easily lubricated and cooled.

Many bearing compartments, especially those located in the forward portions of the gas turbine engine, have small profiles that make their interiors difficult to access for routine maintenance, assembly and repair. For example, to install, clean, or repair an oil nozzle that is commonly bolted within conventional bearing compartments, mechanics must insert their hands or tools into the small interior space within the bearing compartment. As one can imagine, this process can be awkward and time consuming. Additionally, the low-profile of the bearing compartment can necessitate that complex passageways be used for oil distribution within the bearing compartment. These passageways make the bearing compartment, and in particular, the housing more difficult and costly to manufacture.

### SUMMARY

An assembly includes a tube fitting integrally joined with a nozzle and adapted with a plurality of passages to spray lubricating oil at components within a bearing compartment of a gas turbine engine. In another aspect, the tube fitting and the nozzle are attached to a lubrication tube such that the tube fitting and nozzle can be inserted or removed from the bearing compartment along with the lubrication tube without disassembling the bearing compartment.

### BRIEF DESCRIPTION OF THE DRAWINGS

FIG. 1 is a schematic cross-section of a gas turbine engine.

FIG. 2 is a cross-sectional view of a bearing compartment including a combination tube fitting and nozzle attached to a lubrication tube.

### DETAILED DESCRIPTION

The present application describes an integral tube fitting and nozzle combination that is attached to a lubrication tube within a gas turbine engine. This arrangement allows the nozzle and the tube fitting to be installed or removed from a bearing compartment as a single piece structure with installation or removal of the lubrication tube. The integral tube fitting and nozzle can be fully assembled with the lubrication tube outside of the bearing compartment and does not require any fasteners, tooling, or disassembly of the bearing compartment. Thus, the assembly of the lubrication tube, the tube fitting, and the nozzle greatly simplifies installation, cleaning, and repair of various components, including the nozzle. Additionally, this arrangement allows the nozzle to be disposed within the bearing compartment immediately adjacent (so as to spray oil upon) critical components that require lubrication such as a bearing, bearing raceways, and a carbon seal assembly including a carbon seal seat. By disposing the nozzle within the bearing compartment immediately adjacent critical components, problems with the prior art such as oil jet brooming and misdirected oil spray are reduced.

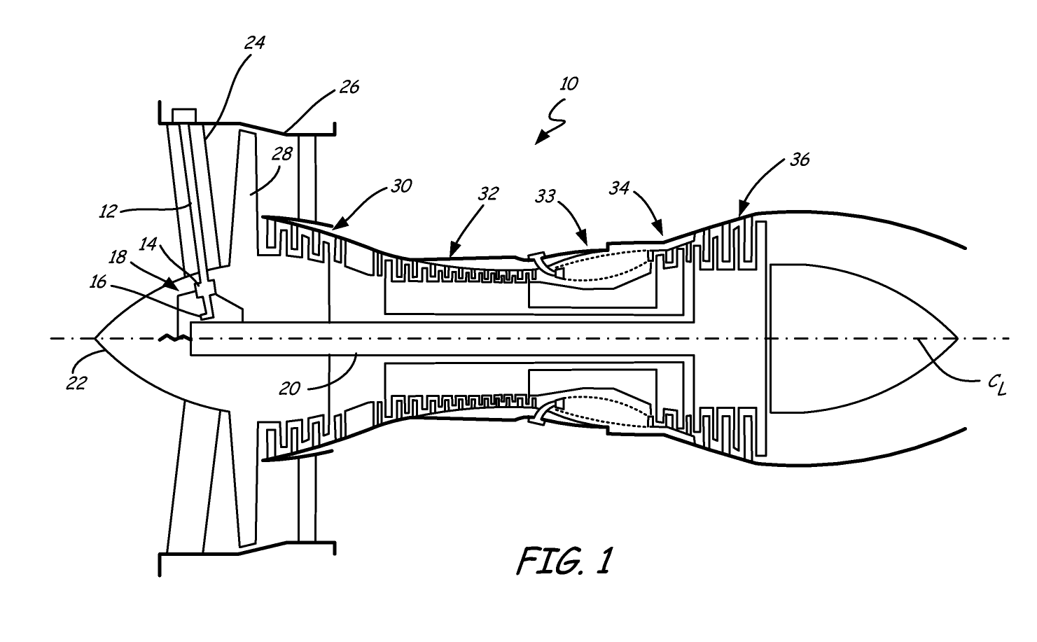

FIG. 1 shows a schematic cross-section of a gas turbine engine 10 with only half of the gas turbine engine 10 illustrating features of the invention. The gas turbine engine 10 includes an oil supply tube or lubrication tube 12, a tube fitting 14, a nozzle 16, a bearing compartment 18, a shaft 20, a nose cone 22, an inlet case strut 24, an inlet case 26, a fan 28, a low pressure compressor 30, a high pressure compressor 32, a combustor 33, a high pressure turbine 34, and a low pressure turbine 36.

The gas turbine engine 10 illustrated in FIG. 1 is a high bypass ratio turbofan engine with a dual spool arrangement. The general construction and operation of gas turbine engines, and in particular turbofan engines, is well-known in the art, and therefore, detailed discussion herein is unnecessary. It should be noted, however, that the engine 10 is shown merely by way of example and not limitation. The present invention is also applicable to variety of other gas turbine engine configurations, including low bypass ratio turbofan engines, for example.

In the embodiment illustrated in FIG. 1, the lubrication tube 12 is disposed in a forward portion of the gas turbine engine 10. The lubrication tube 12 extends through an inlet section of the gas turbine engine 10 to connect to the tube fitting 14. As will be discussed in further detail subsequently, the tube fitting 14 is integrally joined with the nozzle 16. The nozzle 16 is disposed to extend into the bearing compartment 18. The bearing compartment 18 is disposed adjacent the shaft 20 within the nose cone 22.

The inlet case strut 24 extends radially outward (with respect to engine centerline axis C_{L}) and connects with the inlet case 26 forward (as defined by the direction of airflow through the gas turbine engine 10) of the fan 28. In one embodiment, the lubrication tube 12 extends through the inlet case strut 24 to communicate with the remainder of the lubrication system within the gas turbine engine 10. The operation and general construction of lubrication systems are well-known in the art, and are disclosed, for example, in U.S. Pat. No. 6,102,577 to Tremaine, which is incorporated herein by reference.

The fan 28 connects to the shaft 20, which also drives the low pressure compressor 30. A second shaft is disposed radially outward of shaft 20 and connects the high pressure compressor 32 with the high pressure turbine 36. In particular, the gas turbine engine 10 illustrated in FIG. 1 has a dual spool arrangement in which fan 28 and the low pressure compressor 30 are connected to the low pressure turbine 34 by various rotors and shaft 20, and the high pressure compressor 32 is connected to high pressure turbine 36 by the second shaft. Working gas travels through the core of the gas turbine engine 10 through the various sections and components 28, 30, 32, 34, and 36. The working gas is mixed with fuel and ignited in the combustor 33 and is then directed into the turbine sections 34 and 36 where the mixture is successively expanded through alternating stages of airfoils comprising rotor blades and stator vanes to extract mechanical work therefrom.

The inlet case struts 24 can be oriented within the inlet case 26 to direct intake air (working gases) into the forward part of the low pressure compressor 30 or to bypass the low pressure compressor 30. The shaft 20 is supported from non-rotating portions of the gas turbine engine 10 by anti-friction bearings (not shown in FIG. 1). The anti-friction bearings are housed in various bearing compartments, including the bearing compartment 18. The bearing compartment 18 allows the anti-friction bearings therein to be more easily lubricated and cooled.

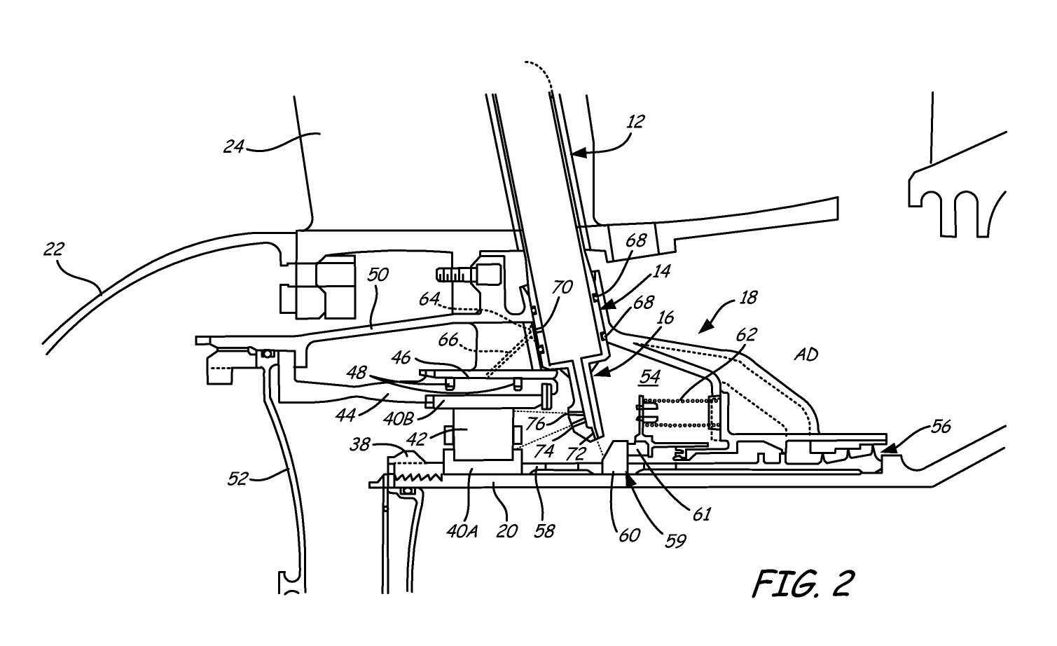

FIG. 2 is a cross-sectional view of the bearing compartment 18. In addition to some of the features shown in FIG. 1, FIG. 2 illustrates components housed within the bearing compartment 18. These components include a nut 38, an inner raceway 40A, an outer raceway 40B, a bearing 42, a centering spring 44, a squeeze film damper 46, piston rings 48, a housing 50, a cover 52, a cavity 54, a labyrinth assembly 56, a spacer 58, a seal assembly 59 that includes a carbon seal seat 60 and a carbon seal 61, and a bias element 62. The housing 50 has an annulus 64 and a passage 66 that are both shown in phantom in FIG. 2. O-rings 68 seal the tube fitting 14 to the housing 50. The tube fitting 14 includes a passage 70. The nozzle 16 includes a first passage 72, a second passage 74, and a third passage 76.

The bearing compartment 18 is disposed within the nose cone 22 adjacent the shaft 20. The nut 38 is housed with the bearing compartment 18 and is adapted to fasten to the shaft 20. The nut 38 abuts the inner raceway 40A, which receives the bearing 42. The bearing 42 is disposed between the inner raceway 40A and the outer raceway 40B.

The centering spring 44 connects to the outer race 40B and housing 50 and is disposed between the outer race 40B and the squeeze film damper 46. The metallic centering spring 44 maintains the positioning of the outer race 40B within the bearing compartment 18 and has a spring rate capable of reacting loads to the housing 50 from the shaft 20 via the bearing 42 and raceways 40A and 40B. Another embodiment of the centering spring 44 includes an integral outer raceway. In one embodiment, the centering spring 44 has passages that allow for the circulation of air and oil around the bearing 44 and raceways 40A and 40B to a forward portion of the bearing compartment 18 adjacent the cover 52. The cavity of the squeeze film damper 46 is bounded by axially spaced apart (with respect to the engine centerline axis C_{L}) piston rings 48. The squeeze film damper 46 is defined radially by the centering spring 44 and the housing 50, which interface one another adjacent the outer raceway 40B.

The housing 50 along with the cover 52, which is connected thereto, almost completely enclose many of the components of the bearing compartment 18. The portion of the housing 50 adjacent to the shaft 20 interfaces with the labyrinth assembly 56 to allow a desired amount of air to flow from air duct AD (illustrated out of plane in phantom). In particular, the labyrinth assembly 56 creates a desired back pressure in the space between the labyrinth assembly 56 and the carbon seal 61.

The spacer 58 is disposed between the seal assembly 59 (in particular, the carbon seal seat 60) and the inner raceway 40A within the cavity 54 of the bearing compartment 18. The bias element 62, in one embodiment a spring, contacts and exerts a desired axial (in other embodiments radial) force on the carbon seal 61, which interfaces with the carbon seal seat 60. The force exerted by bias element 62 on the carbon seal 61 allows a desired amount of air to flow between the carbon seal 61 and the carbon seal seat 60 into the cavity 54 of the bearing compartment 18.

Within the bearing compartment 18, a space between the housing 50 and the tube fitting 14 defines the annulus 64 (illustrated out of plane in phantom) which communicates with the squeeze film damper 46 via passage 66 (illustrated in phantom). The annulus 64 is also bounded by the spaced apart o-rings 68 that seal the tube fitting 14 to the housing 50. Oil communicates from the tube fitting 14 to the annulus 64 via the passage 70. The oil then passes to the squeeze film damper 46 as necessary through passage 66.

As discussed previously, the tube fitting 14 is integrally joined with the nozzle 16. The joining of the two parts can be accomplished by conventional means, for example, by machining both parts from a single piece stock, casting, or welding. The tube fitting 14 is received in the bearing compartment 18 and is connected to the housing 50 by the spaced apart o-rings 68. The tube fitting 14 can be attached to the lubrication tube 16 by conventional means such as swaging, welding, brazing, bonding using structural adhesive composites, or molding from a single piece.

The nozzle 16 extends from the tube fitting 14 into the interior cavity 54 of the bearing compartment 18. In particular, nozzle 16 is disposed within the bearing compartment 18 immediately adjacent to the inner raceway 40A, the outer raceway 40B, the bearing 42, and the carbon seal seat 60. The first passage 72 extends through the nozzle 16 and directs oil in a spray toward the carbon seal seat 60. The second passage 74 extends through nozzle 16 and directs oil in a spray toward the interface between a surface of the bearing 42 and a surface of the inner raceway 40A. The third passage 76 extends through the nozzle 16 and directs oil in a spray toward the interface between a surface of the bearing 42 and a surface of the outer raceway 40B. Thus, the first, second, and third passages 72, 74, and 76 are disposed to provide adequate lubrication to critical components within the bearing compartment 18.

The nut 38 applies a clamping force which reacts through the inner raceway 40A, through spacer 58, to the carbon seal seat 60, which contacts carbon seal 61, and labyrinth assembly 56. The bearing 42 and the inner and the outer raceways 40A and 40B are supported by the centering spring 44 and the squeeze film damper 46. Squeeze film damper systems such as the one disclosed herein are well known in the art and are used to shift critical speeds and/or to increase the dynamic stability of a rotor-bearing system. The centering spring 44 and housing 50 support the outer raceway 40A and react loads back through to the engine case.

As discussed previously, the integral nozzle 16 and the tube fitting 14 allows the assembly to be installed or removed from the bearing compartment 18 as a single piece structure with installation or removal of the lubrication tube 12. The integral tube fitting 14 and nozzle 16 can be fully assembled with the lubrication tube 12 outside of the bearing compartment and does not require any fasteners, tooling, or disassembly of the bearing compartment 18. Thus, the assembly of the lubrication tube 12, the tube fitting 14, and the nozzle 16 greatly simplifies installation, cleaning, and repair of various components including the nozzle 16. Additionally, this arrangement allows the nozzle 16 to be disposed within the bearing compartment 18 immediately adjacent (so as to spray oil more effectively upon) critical components that require lubrication such as the bearing 42, bearing raceways 40A and 40B, and the carbon seal seat 60. By disposing the nozzle 16 within the bearing compartment 18 immediately adjacent to the critical components, problems with the prior art such as oil jet brooming (a tendency of oil spray to cone in shape over a distance) and misdirected oil spray are reduced.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A gas turbine engine including an assembly for distributing lubricating oil within a bearing compartment, comprising:
a tube fitting; and
a nozzle integrally joined with the tube fitting and having a plurality of passages therethrough to spray the lubricating oil at one or more components within the bearing compartment.

2. The gas turbine engine of claim 1, wherein the bearing compartment houses a bearing, a bearing raceway, and a seal assembly therein, and wherein the nozzle is disposed immediately adjacent to at least one of the bearing, the bearing raceway, and the seal assembly.

3. The gas turbine engine of claim 2, wherein the plurality of passages directs oil as a spray toward at least one of the bearing, the bearing raceway, and the seal assembly.

4. The gas turbine engine of claim 3, wherein the plurality of passages includes a first passage that directs oil as a spray toward a carbon seal seat, a second passage that directs oil as a spray toward interface surfaces of the bearing and an inner raceway, and a third passage that directs oil as a spray toward interface surfaces of the bearing and an outer raceway.

5. The gas turbine engine of claim 2, wherein the tube fitting has a passage that communicates with an annulus within the bearing compartment and the annulus is also in communication with a squeeze film damper disposed adjacent the bearing housing and a centering spring.

6. The gas turbine engine of claim 1, wherein the tube fitting and nozzle are integrally joined by machining a single piece stock, casting, or welding.

7. The gas turbine engine of claim 1, wherein a lubrication tube is attached to the tube fitting such that the tube fitting and nozzle are inserted or removed from the bearing compartment along by the lubrication tube.

8. The gas turbine engine of claim 7, wherein the lubrication tube extends through an inlet case strut that is disposed at a forward portion of a gas turbine engine.

9. An assembly for providing a lubricating oil to a bearing compartment, the assembly comprising:
a tube fitting integrally joined with a nozzle to comprise a single piece, the nozzle having a plurality of passages therethrough to spray the lubricating oil at one or more components within the bearing compartment; and
a lubrication tube that is attached to the tube fitting such that the tube fitting and the nozzle are inserted and removed from the bearing compartment by the lubrication tube.

10. The assembly of claim 9, wherein the bearing compartment houses a bearing, a bearing raceway, and a carbon seal seat and wherein the nozzle extends into an interior of the bearing compartment and is disposed immediately adjacent to at least one of the bearing, the bearing raceway, and the carbon seal seat.

11. The assembly of claim 10, wherein the plurality of passages directs oil as a spray toward at least one of the bearing, the bearing raceway, and the carbon seal seat.

12. The assembly of claim 11, wherein the plurality of passages includes a first passage that directs oil as a spray toward the carbon seal seat, a second passage that directs oil as a spray toward interface surfaces of the bearing and an inner raceway, and a third passage that directs oil as a spray toward interface surfaces of the bearing and an outer raceway.

13. The assembly of claim 9, wherein the tube fitting or nozzle has a passage that communicates with an annulus within the bearing compartment and the annulus is also in communication with a squeeze film damper disposed adjacent the bearing housing and a centering spring.

14. The assembly of claim 9, wherein the tube fitting is sealed to the bearing compartment by only an o-ring.

15. The assembly of claim 9, wherein the lubrication tube extends through an inlet case strut that is disposed at a forward portion of a gas turbine engine.

16. A gas turbine engine, comprising:
a bearing compartment mounted within the gas turbine engine, the bearing compartment housing a bearing, a bearing raceway, and a seal assembly therein;
a tube fitting integrally joined with a nozzle to comprise a single piece, the tube fitting connected to the bearing compartment and the nozzle extending into the bearing compartment, the nozzle including a first passage that directs oil toward the seal assembly, a second passage that directs oil toward interface surfaces of the bearing and an inner raceway, and a third passage that directs oil toward interface surfaces of the bearing and an outer raceway; and
a lubrication tube that is attached to the tube fitting, the lubrication tube extends through an inlet case strut that is disposed at a forward portion of the gas turbine engine.

17. The gas turbine engine of claim 16, wherein the tube fitting and the nozzle are inserted or removed from the bearing compartment as a single piece by the lubrication tube.

18. The gas turbine engine of claim 16, wherein the tube fitting or nozzle has a passage that communicates with an annulus within the bearing compartment and the annulus is also in communication with a squeeze film damper disposed adjacent the bearing housing and a centering spring.

19. The gas turbine engine of claim 16, wherein the wherein the tube fitting is connected to the bearing compartment by an o-ring.

20. The gas turbine engine of claim 16, wherein the seal comprises a carbon seal.
